(19) United States
(12) Patent Application Publication
(10) Pub. No.: US 2007/0069670 A1
(43) Pub. Date: Mar. 29, 2007

(54) Controller Device of Cooling Fan

(76) Inventor: Train Lin, Taipei City (TW)

Correspondence Address: HDSL, 4331 STEVENS BATTLE LANE, FAIRFAX, VA, 22033, US

(21) Appl. No.: 11/458,147

(22) Filed: Jul. 18, 2006

(30) Foreign Application Priority Data
Sep. 23, 2005 (TW) 094216428

(51) Int. Cl. H02P 7/06

(52) U.S. Cl. 318/254

(57) ABSTRACT

A PWM controller device of a simple cooling fan includes a fan motor, a driver device, and a PWM controller device. The driver device is electrically connected to the fan motor. The PWM controller device is electrically connected to the fan motor and the driver device. The driver device internally detects the temperature rise variation of the electronic element and drives the fan motor to rotate in high speed. When the fan motor remains in high rotational speed as the temperature of the electronic element decreases, a PWM signal is input to the PWM controller device, which responsively generates a voltage-drop signal to drive the fan motor to its reduce rotational speed. The PWM controller device achieves control similar to that of a MCU, reduces manufacturing costs, and reduces over all physical size of the cooling fan. The invention is suitable for use in compact electronics.

### BACKGROUND OF THE INVENTION

1. Field of the Invention

The present invention relates to a cooling device, and in particular, to an externally connected PWM (Pulse Width Modulation) controller device applicable in a cooling fan.

2. Description of Prior Art

Current focus in the IT and consumer electronics industry is on the development of electronic gadgetries with multi-functions, high computational power, and compact size. Due to high density and high computation power of electronic components, a lot of heat is generated during device operation. A cooling mechanism is therefore required to prevent overheat and enable proper circuit operation. The cooling fan plays a major role in a cooling mechanism in generating sufficient wind flow to increase heat exchange rates, thereby accomplishing fast heat dissipation.

FIG. 1 shows schematic illustrating the architecture of a traditional cooling fan 1, which includes a fan motor 11, and a fan driver device 12 for controlling operation of fan motor 11. Fan driver device 12 includes either a driver IC or a MCU (Micro-Controller Unit), a Hall element, and a temperature sensor. The Hall element and the temperature sensor detect the temperature variation of the electronic element, and the driver IC or the MCU triggers fan motor 11 to generate rotation or adjust rotational speed based on temperature variation.

However, the traditional temperature-controlled speed adjustment design of cooling fans are physically limited in size due to the structural nature of the electronic elements and wires, and can not be reduced to less than 6 cm. Hence, the traditional model does not satisfy the current design trend for lightweight and compact electronics. Also, the servo control of traditional cooling fan does not reach a fast, stable, and flawless state. Although the use of a MCU may solve such a problem, the implementation of a MCU means a 2 to 3 times increase in costs as compared to a traditional architecture, and works in no favor to bring down the manufacturing size to less than 6 cm.

### SUMMARY OF THE INVENTION

The invention is to solve the afore-mentioned problems. The invention utilizes simple PWM controller device design, and directly attaching the PWM controller externally to a cooling fan motor. The driver device internally detects the temperature variation of an electronic element, and drives the fan motor to operate in high rotational speed accordingly. When the temperature of the electronic element is reduced, the fan motor yet remains in high rotational speed. To reduce the rotational speed, a PWM signal is input to the PWM controller device, such that a voltage-drop signal is generated therefrom to drive the fan motor to reduce rotational speed effectively. The PWM controller device functions nearly the same as a MCU, while also reduces manufacturing costs and overall physical size that are suitable for use in compact electronic devices.

The invention provides a controller device of a cooling fan that includes a fan motor, a driver device, a PWM controller device and a PWM signal. The driver device is connected to the fan motor. The PWM controller device is connected to the fan motor and the driver device. The PWM signal is input to the PWM controller device. The PWM controller device generates a voltage-drop signal after the PWM signal is being input thereto. The voltage-drop signal drives the fan motor to reduce rotational speed.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is circuit schematic illustrating the architecture of a traditional cooling fan;

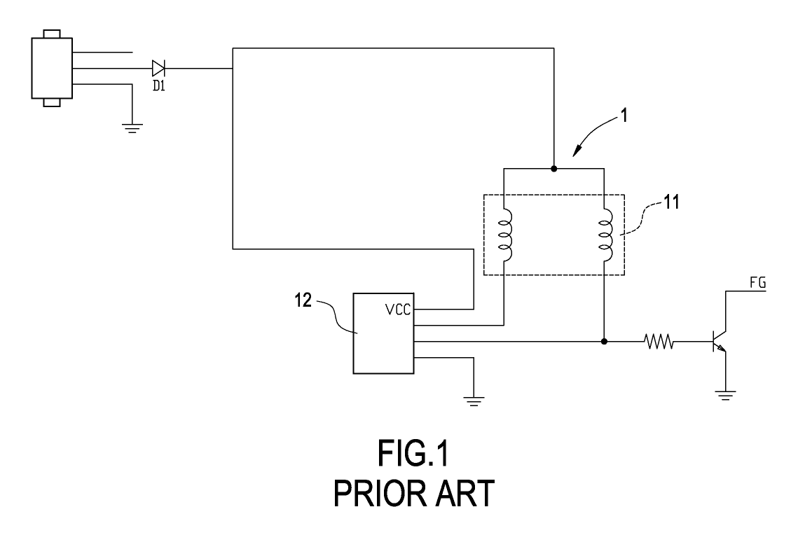

FIG. 2 is block diagram illustrating a controller device according to a preferred embodiment of the invention;

FIG. 3 is a circuit schematic illustrating controller device according to a preferred embodiment of the invention; and

FIG. 4 is circuit schematic illustrating a controller device according to another preferred embodiment of the invention.

### DETAILED DESCRIPTION OF THE INVENTION

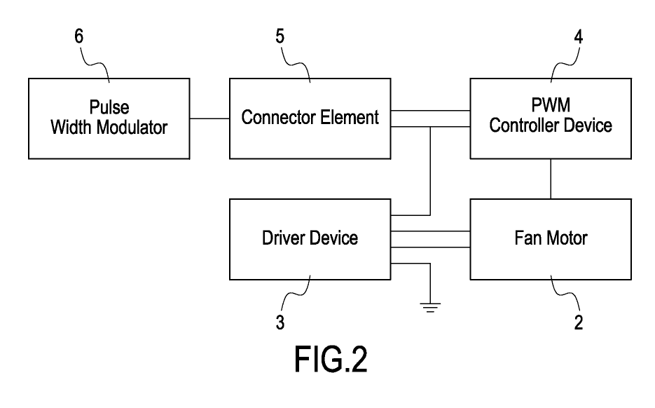

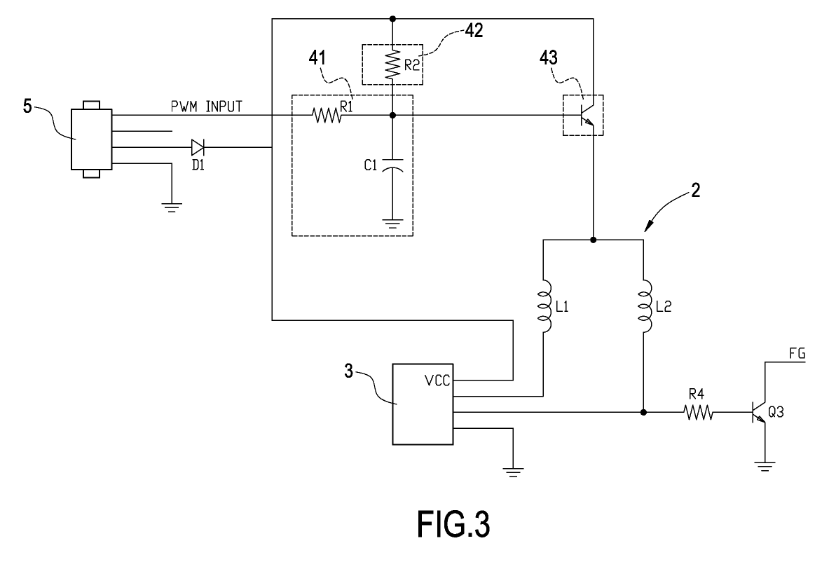

FIGS. 2 and 3 are schematics illustrating a controller device in a half-wave configuration according to a preferred embodiment of the invention. FIG. 3 is a circuit schematic illustrating a controller device according to a preferred embodiment of the invention. As shown in FIGS. 2 and 3, the controller device of a simple cooling fan includes a fan motor 2, a driver device 3, a PWM controller device 4, and a connector element 5. The driver device 3 is connected to the fan motor 2. The PWM controller device 4 is connected to the fan motor 2 and the driver device 3. The connector element 5 is electrically connected to PWM controller device 4 to input the external PWM signal. The above-mentioned elements collectively form a simple, low-cost externally added PWM controller device to be applied in a cooling fan, allowing the overall size of the cooling fan to be manufactured less than 4 cm, and providing a cooling fan having PWM control capability that is near that of a MCU.

The coils L1 and L2 of the above described fan motor 2 are controlled by driver device 3 for causing fan motor rotation.

The power supply signal input terminal of driver device 3 is connected to the external power supply through connector element 5, and the output terminal of driver device 3 is connected to coils L1 and L2 of fan motor 2. The amount of current flowing from the output terminal of driver device 3 to coils L1 and L2 is controlled based on the temperature variation of an electronic element detected internally by driver device 3, so as to control the rotational speed of fan motor 2, and maintain fan motor 2 at high rotational speeds when the temperature increases. Thus, the electronic element is prevented from being overheat.

PWM controller device 4 includes at least a charge/discharge circuit (RC circuit) 41, a voltage-drop generation circuit 42, and an electronic switch 43. Charge/discharge circuit 41 is realized by a resistive element R1 and a capacitive element C1. Voltage-drop generation circuit 42 is realized by a resistive element R2. Electronic switch 43 is realized by a transistor.

When the temperature of the electronic element is detected by the driver device 3 to be increasing, then the rotational speed of fan motor 2 also increases. However, when the temperature of the electronic element is detected by driver device 3 to be decreasing, the rotational speed of fan motor does not decease without the following operation. The external PWM 6, connected to connector element 5, inputs a PWM signal to PWM controller device 4, which induces the charging of capacitive element C1 via the resistive element of charge/discharge circuit 41. After capacitive element C1 is charged, the resistive element R2 of voltage/drop generation circuit 42 is subsequently discharged, and a voltage drop is thus generated across resistive element R2. The voltage drop signal causes the electronic switch 43 to turn on so as to control fan motor 2 to reduce its rotational speed to accurately correspond with the temperature of the electronic element.

PWM 6 is a signal modulator configured external to the above-mentioned cooling fan. Based on the temperature drop variation of the electrical sensor element, PWM 6 outputs a PWM signal as a trigger signal for initiating PWM controller device 4 operation.

The advantage of the controller device of the present invention has low manufacturing cost, since the PWM controller device 4 is designed as an external add-on connection to a existing cooling fan and its fan motor 2, and is only comprised of charge/discharge circuit 41, voltage-drop generation circuit 42 and electronic switch 43, which in combination with PWM 6 forms a simple control circuit functioning as a trigger control for PWM controller device 4. ( [symbol] )

Also, the invention effectively allows the physical size of the cooling fan to be reduced, to less than 4 cm, by utilizing a simple control design of PWM controller device 4 and a PWM 6 and applying in a cooling fan, and thereby satisfying the current trend for compact designs. Also, by making appropriate rotational speed adjustment in correspondence with the temperature variation, the invention achieves control efficiency close to that of a higher-cost MCU.

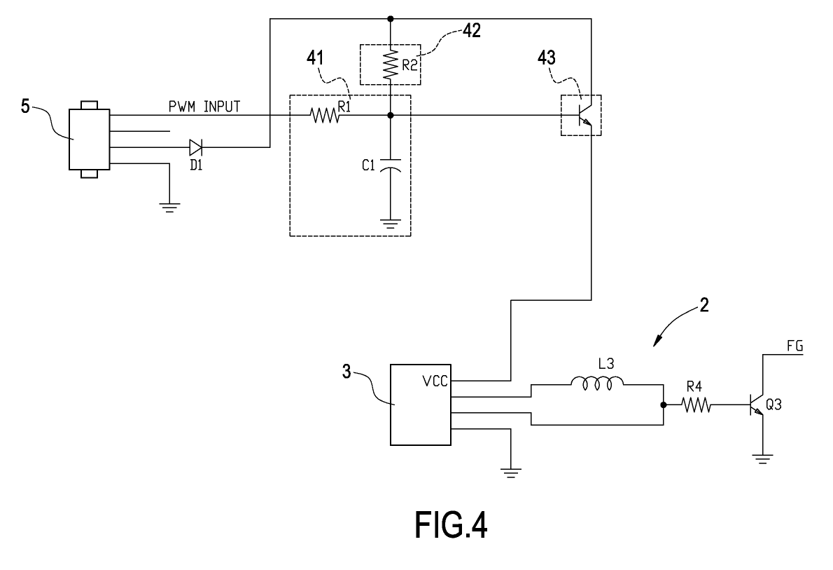

FIG. 4 is circuit schematic illustrating a controller device of a cooling fan according to a preferred embodiment of the invention applied in a full-wave configuration. As shown in the figure, the current embodiment is similar to the embodiments shown in FIGS. 2 and 3, and differs in that the coil L3 of fan motor 2 is in a full-wave configuration. The coil L3 is connected to the simple PWM controller device 4 of the present invention, and works in collaboration with the externally connected PWM 6, which outputs signals to trigger PWM controller device 4 to turn on. Thus, as previous embodiments, the PWM controller device 4 can be controlled to output a voltage-drop signal to trigger fan motor 2 to reduce its rotational speed based on the detected temperature variation of the electronic element, and thereby successfully providing user with a more compact, and cheap PWM controller device for application in a cooling fan that achieves control capabilities similar to that of a higher-cost MCU.

Although the present invention has been explained in relation to its preferred embodiment, it is to be understood that many other possible modifications and variations can be made without departing from the spirit and scope of the invention as hereinafter claimed.

What is claimed is:

1. A controller device of a simple cooling fan, comprising:
a fan motor;
a driver device connected to the fan motor;
a PWM controller device connected to the fan motor and the driver device; and
a PWM signal being input to the PWM controller device;
wherein the PWM controller device generates a voltage-drop signal after the PWM signal is being input thereto, the voltage-drop signal driving the fan motor to reduce rotational speed.

2. The controller device as claimed in claim 1, wherein the PWM controller device includes:
a charge/discharge circuit;
a voltage-drop generation circuit electrically connected to the charge/discharge circuit; and
an electronic switch electrically connected to the charge/discharge circuit and the voltage-drop generation circuit.

3. The controller device as claimed in claim 2, wherein the charge/discharge circuit is a RC circuit formed by a resistive element R1 and a capacitive element C1.

4. The controller device as claimed in claim 2, wherein the voltage-drop generation circuit is formed by a resistive element R1.

5. The controller device as claimed in claim 2, wherein the electronic switch is a transistor element.

6. The controller device as claimed in claim 1, wherein the PWM controller device is electrically connected to a connector element.

7. The controller device as claimed in claim 1, wherein the connector element is electrically connected to a PWM externally.

8. The controller device as claimed in claim 1, wherein the PWM controller device is connected to a fan motor driver circuit in either a full-wave or a half-wave configuration.
